(19) United States
(12) Patent Application Publication
(10) Pub. No.: US 2008/0000270 A1
(43) Pub. Date: Jan. 3, 2008

(54) Suspension-cum-holding device for an optical fiber preform

(76) Inventors: Jijo Paul, Kerala (IN); Saravanan Guru, Maharashtra (IN)

Correspondence Address: LOWE HAUPTMAN HAM & BERNER, LLP, Suite 310, 1700 Diagonal Road, Alexandria, VA, 22314, US

(21) Appl. No.: 11/592,899

(22) Filed: Nov. 3, 2006

(30) Foreign Application Priority Data
Jul. 3, 2006 (IN) 1056/MUM/2006

(51) Int. Cl. C03B 37/01

(52) U.S. Cl. 65/427; 65/494

(57) ABSTRACT

An improved suspension-cum-holding device for an optical fiber preform 21 comprising a cylindrical body 22 consisting of a closed top end 23 and open bottom end 24 is disclosed, wherein the closed top end 23 is provided with a securing means 25 capable of securing the suspension-cum-holding device 21 in the furnace, the cylindrical body 22 being provided with an opening 26 towards the closed top end 23, characterized in that the opening 26 extends rearward to form a cylindrical hollow body 27 which is provided with two openings 28 and 29 in its lower surface, wherein the openings 28 and 29 extend downwards respectively to form cylindrical bodies 28a and 29a, wherein the cylindrical body 28a and cylindrical body 29a join and merge with each other at a point 30 forming a body 31, wherein the cylindrical body 27 is provided with a ball support means 32 at the interface of cylindrical body 27 and cylindrical body 29a which is capable of supporting the handle ball 11B provided on the preform handle 11 of the optical fiber preform 12.

### FIELD OF THE INVENTION

The present invention relates to an improved suspension-cum-holding device for an optical fiber preform. Particularly it relates to an improved suspension-cum-holding device for suspending and holding an optical fiber preform in a sintering furnace. More particularly it relates to an improved suspension-cum-holding device, for suspending and holding an optical fiber preform in a sintering furnace, which does not expand on heating at about 1500 to 1600 degree C. temperature and can hold a preform weighing more than about 20 Kg.

### BACKGROUND OF THE INVENTION

The optical fibers are inherently versatile as a transmission medium for all forms of information, be it voice, video or data. The primary object of telecommunication industry is to transmit greater amount of information, over longer distances, in shorter period of time. This object can be fulfilled with the optical fibers having desired characteristics, for example having low optical attenuation loss in the wavelength range varying from about 1300 nm to about 1625 nm.

The optical fiber is drawn from optical fiber preform. The optical fiber preform generally comprises a central core and an outer cladding. The core rod itself comprises a core and part of cladding of the fiber preform. Conventionally, the core rod can be prepared by any known method. For example, the core rod can be prepared by Atmospheric Chemical Vapor Deposition (ACVD) method, wherein the soot is deposited during the deposition process step on the cylindrical member (also referred as target rod or mandrel) to form soot porous body. In this method, the soot deposition may be accomplished by traverse motion of the target rod over the burners or vice versa. The initial soot deposition comprises dopant chemicals to increase refractive index of the core to the desired value and dopant chemicals are terminated after desired core diameter is obtained. The deposition process continues until the required dimension of the soot porous body is attained for meeting desired core diameter in the optical fiber preform and the desired core-clad diameter ratio in the fiber. Typically, a single mode optical fiber may have core of about 8-10 μm in diameter and clad of about 125 μm in diameter. After completion of soot deposition, the target rod is removed from the soot porous body to form hollow cylindrical soot porous body defining a capillary at the center [also referred as hollow soot porous body]. A glass plug is preferably inserted into the end remote from the handle of the hollow soot porous body. The hollow soot porous body is, thereafter, moved into a sintering furnace, wherein this hollow soot porous body is first dehydrated and then sintered (also known as vitrification or consolidation) in a chlorine and helium atmosphere to form optical fiber preform at about 1500° C. or above.

The dehydration and sintering processes can be carried out by any method known in the art. For example, it can be carried out inside specially built furnaces that are equipped with one or more heating elements and gas input mechanisms. The dehydration and sintering processes comprise inserting the hollow cylindrical soot porous body into a sintering furnace and subjecting it to a temperature regime under controlled chemical environment to form sintered glass preform. The chemical environment necessary for dehydration can be provided with the help of gases that promote dehydration, and the chemical environment that is necessary for sintering can be provided with gases that are inert and have high thermal conductivity.

For dehydration and sintering processes, the hollow cylindrical soot porous body is inserted into a sintering furnace after suspending into a suspension-cum-holding device which holds the preform during dehydration and sintering process.

Referring to accompanying FIGS. 1, 1a, 1b and 1c, the conventionally known suspension-cum-holding device 1 for an optical fiber preform comprises a cylindrical body 2 consisting of a closed top end 3 and open bottom end 4 wherein the closed top end 3 is provided with a securing means 5 suitable for/capable of securing the suspension-cum-holding device 1 in the chuck provided in the top end of the furnace [not illustrated in Figures]. The cylindrical body 2 is provided with an upper opening 6 towards the closed top end 3 and a lower opening 7 towards the open bottom end 4 wherein the openings 6 and 7 join and merge with each other at point 10 forming a ball support means 8 towards the opposite end of the openings 6 and 7 suitable for/capable of supporting the handle ball 11B provided on the preform handle 11 of the optical fiber preform 12, and the upper opening 6 has same width W6 [or diameter d6] through its depth D6 and the lower opening 7 has same width W7 (diameter d7) through its depth D7.

The width W6 [or diameter d6] of the upper opening 6 is greater than width W7 [or diameter d7] of the lower opening 7 so that handle ball 11B provided on the preform handle 11 of the optical fiber preform 12 can pass through the upper opening 6 and sit in the ball support means 8 of the device 1.

The openings 6 and 7 may be elliptical or cylindrical [FIGS. 1, 1a, 1b] in shape having width W6 and W7 respectively or circular [not illustrated in Figure] in shape having diameter d6 or d7 respectively.

In accordance with conventional practice, a preform handle 11 comprising a handle rod 11A and handle ball 11B provided on top end of the handle rod 11A is made to pass through the openings 6 and 7 in such a way that handle ball 11B passes through upper opening 6 and upper part of handle rod 11A passes through the lower opening 7 and the handle ball 11B is made to sit on the ball support means 8.

Therefore, the width W6 [or diameter d6] of the upper opening 6 is such that it is suitable for handle ball 11B to pass through and width W7 [or diameter d7] of the lower opening 7 is such that it is suitable for handle rod 11A to pass through, and the width [or diameter] of the ball support means 8 is such that it is suitable for supporting the handle ball 11B.

The main problem of the conventionally known suspension-cum-holding device 1 is that when it is heated during drying and sintering process steps, it deforms, at about 1500 to 1600 degree C. temperature, in such a way that the lower opening 7 expands which results in tilting of the preform suspended therethrough. The titled preform results in bending of the preform or in formation of a curve in the preform body which in-turn has been observed to cause difficulties in drawing of a fiber and if fiber is drawn then the drawn fiber is observed to have clad ovality which causes problems in fiber splicing.

The another main problem of the conventionally known suspension-cum-holding device 1 is that when it is heated during sintering process steps, it further deforms, at about 1500 to 1600 degree C. temperature, in such a way that the lower opening 7 expands to such an extent that the preform slips from the ball supporting means 8 thereby resulting in loss of entire preform. It has been observed that when a preform falls in the furnace during the sintering process step it also damages the furnace thereby resulting in loss of the sintering furnace.

Still another problem of the conventionally known suspension-cum-holding device 1 is that these are not suitable to hold the preform weighing more than about 20 Kg.

Accordingly, the conventionally known suspension-cum-holding device has been observed to suffer from the problem of expansion resulting either in tilting of the preform or in slipping of the preform and incapable of holding a preform weighing more than about 20 Kg.

### NEED OF THE INVENTION

Therefore, there is a need to have an improved suspension-cum-holding device which does not suffer from above-described problems, that is which does not suffer from the problem of expansion resulting either in tilting of the preform or in slipping of the preform and is still capable of holding a preform weighing more than about 20 Kg.

### OBJECTION OF THE INVENTION

Accordingly, main object of the present invention is to provide an improved suspension-cum-holding device which does not suffer from above-described problems of the prior art, that is which neither suffers from the problem of expansion resulting either in tilting of the preform or in slipping of the preform nor suffers from the incapability of holding a preform weighing more than about 20 Kg, that is, which is also suitable for holding a preform weighing more than about 20 Kg.

The other objects and preferred embodiments and advantage of the present invention will become more apparent from the following description of the present invention when read in conjunction with the accompanying drawings which are not intended to limit scope of the present invention.

### BRIEF DESCRIPTION OF THE ACCOMPANYING DRAWINGS

FIG. 1 illustrates front-perspective view of a conventionally known suspension-cum-holding device for an optical fiber preform.

FIG. 1a illustrates front view of a conventionally known suspension-cum-holding device for an optical fiber preform.

FIG. 1b illustrates bottom view of a conventionally known suspension-cum-holding device for an optical fiber preform.

FIG. 1c illustrates front view of a conventionally known suspension-cum-holding device for an optical fiber preform holding a preform.

FIG. 2 illustrates front-perspective view of suspension-cum-holding device for an optical fiber preform in accordance with present invention.

FIG. 2a illustrates front view of suspension-cum-holding device for an optical fiber preform in accordance with present invention.

FIG. 2b illustrates expanded view of opening 26 of suspension-cum-holding device for an optical fiber preform shown in FIG. 2 in accordance with present invention.

FIG. 2c illustrates bottom view of suspension-cum-holding device for an optical fiber preform in accordance with present invention.

FIG. 2d illustrates front view of suspension-cum-holding device for an optical fiber preform holding a preform in accordance with present invention.

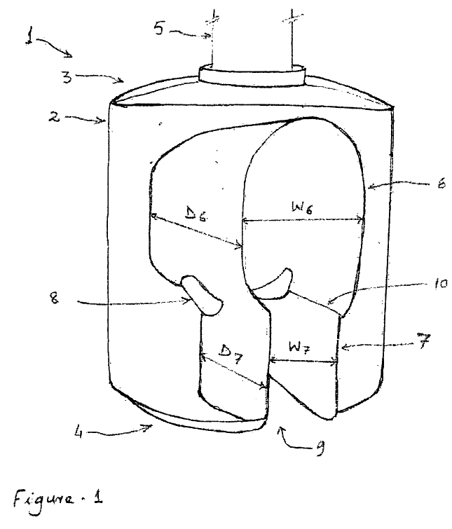

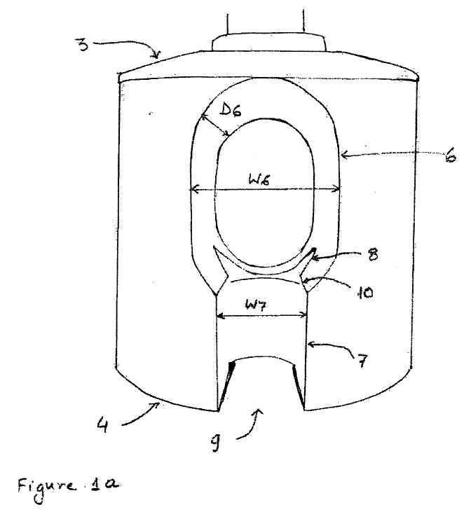

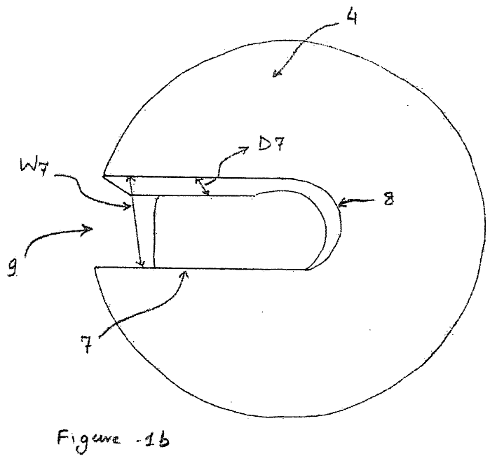

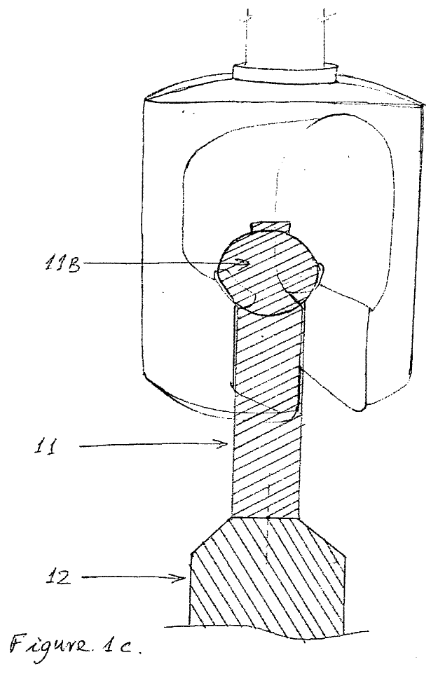

### BRIEF DESCRIPTION OF THE INVENTION

The conventionally known suspension-cum-holding device has been observed to suffer from the problem of expansion thereby resulting either in tilting of the preform or in slipping of the preform. Further, the conventionally known suspension-cum-holding device has also been observed to suffer from the problem of its incapability of holding a preform weighing more than about 20 Kg.

The inventors of the present invention have observed that if lower opening of suspension-cum-holding device is closed and width [or diameter] of the lower opening of suspension-cum-holding device is reduced towards its rear end, then it surprisingly overcomes problem of expansion thereby avoids tilting of the preform when held in the suspension-cum-holding device and slipping of the preform from the suspension-cum-holding device into the sintering furnace.

The inventors of the present invention have also observed that such improved suspension-cum-holding device is suitable for holding a preform weighing more than about 20 Kg thereby overcomes problem of holding a preform weighing more than about 20 Kg.

Accordingly, the present invention relates to an improved suspension-cum-holding device for an optical fiber preform comprising a cylindrical body consisting of a closed top end and open bottom end wherein the closed top end is provided with a securing means capable of securing the suspension-cum-holding device in the furnace, the cylindrical body being provided with an opening towards the closed top end, characterized in that the opening extends rearward to form a cylindrical hollow body which is provided with two openings in its lower surface, wherein the openings extend downwards respectively to form cylindrical bodies, wherein the cylindrical bodies join and merge with each other at a point forming a body, wherein the cylindrical body is provided with a ball support means at the interface of cylindrical body and cylindrical body which is capable of supporting the handle ball provided on the preform handle of the optical fiber preform.

### DETAILED DESCRIPTION OF THE INVENTION

Accordingly, the present invention relates to an improved suspension-cum-holding device for an optical fiber preform which overcomes problem of expansion thereby avoids tilting of the preform when held in the suspension-cum-holding device and slipping of the preform from the suspension-cum-holding device into the sintering furnace, and at the same time is capable of holding a preform weighing more than about 20 Kg thereby overcomes problem of holding a preform weighing more than about 20 Kg.

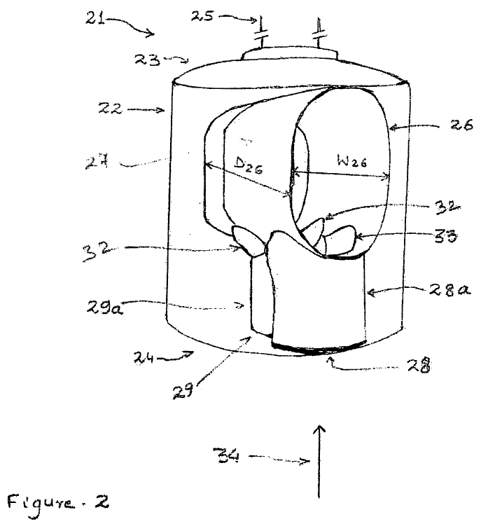

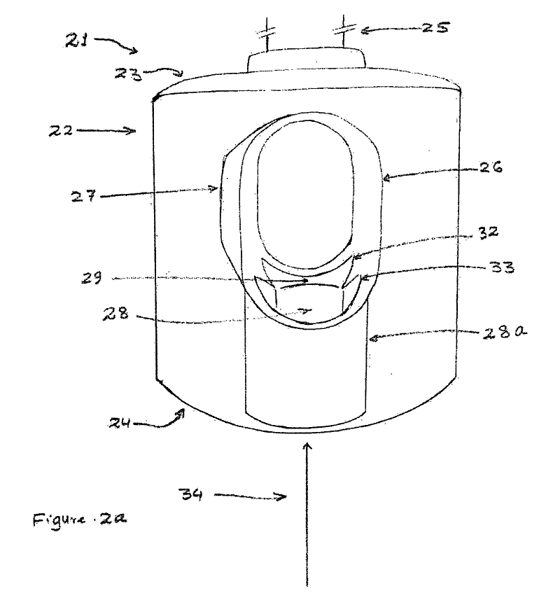

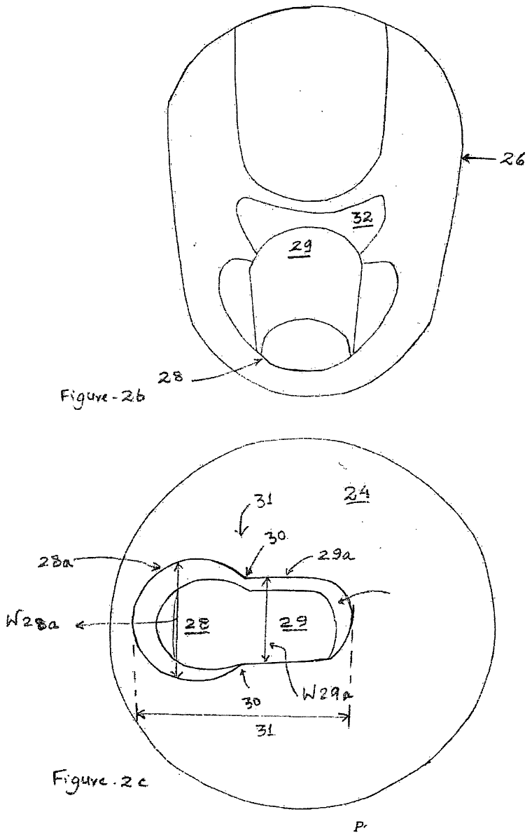

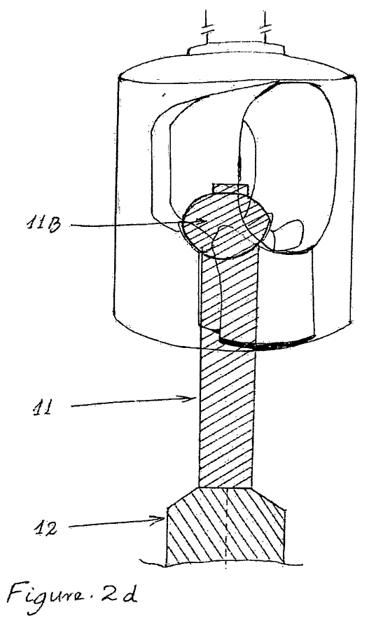

Now referring to accordance with accompanying FIGS. 2, 2a, 2b, 2c and 2d, in accordance with present invention, the suspension-cum-holding device 21 for an optical fiber preform comprises a cylindrical body 22 consisting of a closed top end 23 and open bottom end 24 wherein the closed top end 23 is provided with a securing means 25 suitable for/capable of securing the suspension-cum-holding device 21 in the chuck provided in the top end of the furnace [not illustrated in FIG. 2], the cylindrical body 22 is provided with an opening 26 towards the closed top end 23, characterized in that the opening 26 having a width W26 [or diameter d26] and depth D26 extends rearward to form a cylindrical hollow body 27 which is provided with two openings 28 and 29 in its lower surface, wherein the openings 28 and 29 extend downwards respectively to form cylindrical bodies 28a and 29a, wherein the cylindrical body 28a having a width W28a [or diameter d28a] and cylindrical body 29a having W29a [or diameter d29a] join and merge with each other at point 30 forming a body 31 [combination of bodies 28a and 29a], wherein the cylindrical body 27 is provided with a ball support means 32 at the interface of cylindrical body 27 and cylindrical body 29a suitable for/capable of supporting the handle ball 11B provided on the preform handle 11 of the optical fiber preform 12.

In accordance with present invention, the width W26 [or diameter d26] of the opening 26 is equal to or greater than the width W28a [or diameter d28a] of the cylindrical body 28a, and the width W29a [or diameter d29a] of the cylindrical body 29a is less than the width W26 [or diameter d26] of the opening 26 and is also less than the width W28a [or diameter d28a] of the cylindrical body 28a so that the handle ball 11B provided on the preform handle 11 of the optical fiber preform 12 can pass through the cylindrical body 28a and front part of cylindrical body 27 and be pushed back towards rear end of the cylindrical body 27 so as to sit on the ball supporting means 32 and the preform handle 11 can fit in the cylindrical body 29a.

In accordance with one of the preferred embodiments of the present invention, the opening 26 has same width W26 [or diameter d26] through its depth D26.

In accordance with another preferred embodiment of the present invention, the opening 26 may also be closed.

In accordance with another preferred embodiment of the present invention, the upper part 33 of the cylindrical body 28a has greater width [or diameter] than its lower part so as to make the handle ball 11B to comfortably slide towards rear end of the cylindrical body 27.

In accordance with one of the preferred embodiments of the present invention, the opening 26, and cylindrical bodies 27, 28a and 29a are elliptical in shape.

In accordance with another preferred embodiment of the present invention, the opening 26, and cylindrical bodies 27, 28a and 29a are circular in shape. The opening 26, and cylindrical bodies 27, 28a and 29a when elliptical in shape may have width W26, W26, W28a and W29a, and when circular in shape may have diameter d26, d26, d28a and d29a [not illustrated in Figure.].

In accordance with present invention, a preform handle 11 comprising a handle rod 11A and handle ball 11B provided on top end of the handle rod 11A is pushed upward in the direction of the arrow 34 through the cylindrical body 28a in such a way that handle ball 11B passes through the cylindrical body 28a and rests in front part of the cylindrical body 27 wherein the preform handle 11 is pushed back towards rear end of the cylindrical body 27 so that the handle ball 11B sits on the ball supporting means 32 and the preform handle 11 fits in the cylindrical body 29a.

Therefore, the width W26 [or diameter d26] of the cylindrical body 27 and the width W28a [or diameter d28a] of the cylindrical body 28a are such that these are compatible with the handle ball 11B of the preform handle 11 and width W29a [or diameter d29a] of the cylindrical body 29a is such that it is suitable for the handle rod 11A to pass through, and the width [or diameter] of the ball support means 32 is such that it is suitable for supporting the handle ball 11B.

It may be noted that the scope of the present invention is not restricted by widths [or diameters] of cylindrical bodies of the presently disclosed device, which may vary depending upon the diameters of the handle ball 11B and handle rod 11A of the preform handle 11.

It has been observed that when the presently disclosed suspension-cum-holding device 21 is heated during drying and sintering process steps, it does not deform even at about 1500 to 1600 degree C. temperature thereby avoids tilting of the preform suspended therethrough, and hence overcome the problem of bending of the preform or formation of a curve in the preform body which in-turn overcomes difficulties in drawing of a fiber and thereby avoids the problem of clad ovality in the drawn fiber, and therefore, avoids problems in fiber splicing.

Accordingly, the process for processing a preform by employing the presently disclosed suspension-cum-holding device does not suffer from the problems of tilting of the preform when it is suspended in the presently disclosed suspension-cum-holding device, bending of the preform when it is suspended in the presently disclosed suspension-cum-holding device, formation of a curve in the preform body when it is suspended in the presently disclosed suspension-cum-holding device.

Further, the process of drawing a fiber from the preform processed by employing presently disclosed suspension-cum-holding device is free from unwanted difficulties thereby avoids the problem of clad ovality in the drawn fiber, and therefore, avoids problems in fiber splicing.

As no deformation of the presently disclosed suspension-cum-holding device has been observed during sintering process step even at 1500 to 1600 degree C. temperature, the preform being processed while using the presently disclosed suspension-cum-holding device does not slip down from the ball supporting means thereby the presently disclosed suspension-cum-holding device overcomes problems of loss of preform and damages of the sintering furnace.

The presently disclosed suspension-cum-holding device has also been found to be capable of holding a preform weighing more than about 20 Kg.

Accordingly, the presently disclosed suspension-cum-holding device has been surprisingly observed to overcome problem of expansion and hence, the problems of tilting of the preform in the suspension-cum-holding device and slipping down of the preform from the suspension-cum-holding device, and simultaneously has also been observed to overcome the problem of incapability of holding a preform weighing more than about 20 Kg.

For experimental studies, the optical fiber preform prepared by ACVD method was suspended and held in sintering furnace with the help of a conventional suspension-cum-holding device. It was observed that just after 40 to 50 number of processings the conventional suspension-cum-holding device expanded and caused tilting in the preform, and after 45 to 50 number of processings the conventional suspension-cum-holding device further expanded and the preform slipped therefrom and fell into the sintering furnace thereby causing loss of the preform and damage to the sintering furnace, and it was also observed that the conventional suspension-cum-holding device could not hold a preform weighing more than about 20 Kg.

For experimental studies, the optical fiber preform prepared by ACVD method was also suspended and held in sintering furnace with the help of presently disclosed suspension-cum-holding device. It was observed that even after more than 950 to 1000 number of processings the conventional suspension-cum-holding device did not expand and hence, avoided problems of tilting in the preform and slipping of the preform from the suspension-cum-holding device. It was also observed that the presently disclosed suspension-cum-holding device was capable of suspending and holding performs weighing more than about 20 Kg.

In one embodiment, the present invention also includes a process for processing an optical fiber preform by suspending the same in the presently disclosed suspension-cum-holding device.

The present invention has been described with exemplary reference to ACVD method. However, the presently disclosed suspension-cum-holding device has been found to be suitable in other methods to manufacture optical fiber preform.

Further, the presently disclosed suspension-cum-holding device has also been found to be suitable to process performs for single mode optical fiber as well as for multi mode optical fiber.

It may also be noted that various modifications are possible of the presently disclosed suspension-cum-holding device without deviating from the intended scope of the present invention. Accordingly, in one embodiment, such modifications of the presently disclosed suspension-cum-holding device are included in the scope of present invention.

1-12. (canceled)

13. An improved suspension-cum-holding device for an optical fiber preform comprising a cylindrical body consisting of a closed top end and open bottom end wherein the closed top end is provided with a securing means capable of securing the suspension-cum-holding device in the furnace, the cylindrical body being provided with an opening towards the closed top end, characterized in that the opening extends rearward to form a cylindrical hollow body which is provided with two openings in its lower surface, wherein the openings extend downwards respectively to form cylindrical bodies, wherein the cylindrical bodies join and merge with each other at a point forming a body, wherein the cylindrical body is provided with a ball support means at the interface of cylindrical bodies which is capable of supporting the handle ball provided on the preform handle of the optical fiber preform.

14. A device of claim 13, wherein width (or diameter) of said opening is equal to or greater than the width (or diameter) of said cylindrical body.

15. A device of claim 13, wherein width (or diameter) of said cylindrical body is less than said width (or diameter) of said opening and is also less than said width (or diameter) of said another cylindrical body.

16. A device of claim 13, wherein said opening preferably has same width (or diameter) through its depth.

17. A device of claim 13, wherein said opening is preferably closed.

18. A device of claim 13, wherein the upper part of said cylindrical body has greater width (or diameter) than its lower part so as to make said handle ball to comfortably slide towards rear end of said cylindrical body.

19. A device of claim 13, wherein said opening, and said cylindrical bodies are elliptical in shape.

20. A device of claim 13, wherein said opening, and said cylindrical bodies are circular in shape.

21. A device of claim 13, wherein said width (or diameter) of said cylindrical body and said width (or diameter) of said another cylindrical body are compatible with said handle ball of said preform handle.

22. A device of claim 13, wherein said width (or diameter) of said cylindrical body is suitable for said handle rod to pass through.

23. A device of claim 13, wherein the width (or diameter) of said ball support means is suitable for supporting said handle ball.

24. A process for processing an optical fiber preform by suspending the preform in suspension-cum-holding device of claim 13.
